(19) United States
(12) Patent Application Publication
(10) Pub. No.: US 2025/0094551 A1
(43) Pub. Date: Mar. 20, 2025

(54) BATTERY SECURITY SYSTEMS AND METHODS

(71) Applicant: Paired Power, Inc., Campbell, CA (US)

(72) Inventors: Maxym Makhota, Campbell, CA (US); David Thompson McCalmont, Palo Alto, CA (US)

(21) Appl. No.: 18/890,404

(22) Filed: Sep. 19, 2024

Related U.S. Application Data
(60) Provisional application No. 63/584,083, filed on Sep. 20, 2023.

(51) Int. Cl. G06F 21/31

(52) U.S. Cl. CPC G06F 21/31

(57) ABSTRACT

Example battery security systems and methods are described. In one implementation, a control system manages access to at least one battery and a battery module controls access to energy stored in a battery core. The battery module also includes a battery operation manager that controls operation of the battery module and a security manager that controls security of the battery module by storing security keys, storing tokens, retrieving security keys, retrieving tokens, validating security keys, validating tokens, or communicating with the control system for validation of the battery module.

### CROSS REFERENCE TO RELATED APPLICATIONS

This application claims the benefit of U.S. Provisional Application Ser. No. 63/584,083, entitled “Battery Security Systems and Methods,” filed Sep. 20, 2023, the disclosure of which is incorporated herein by reference in its entirety.

### TECHNICAL FIELD

The present disclosure relates to battery security systems and methods that prevent or discourage the theft of batteries and related devices.

### BACKGROUND

Batteries are used to store energy in a variety of situations and environments. For example, alternative energy sources, such as solar power, wind power, and the like, may use batteries to store the energy they generate. In some situations, the energy is stored in a battery for future access by another device or system.

The batteries used to store energy can be expensive, which may attract thieves who want to steal the batteries. Therefore, it is desirable to provide a system that prevents or discourages theft of batteries.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment of a battery system for storing energy.

FIG. 2 is a block diagram depicting another embodiment of a battery system for storing energy.

FIG. 3 is a block diagram depicting another embodiment of a battery system for storing energy.

FIG. 4 is a block diagram depicting an embodiment of a control system included in a battery system for storing energy.

FIG. 5 is a block diagram depicting an embodiment of a battery module including a battery management system and a battery core.

FIG. 6 is a block diagram depicting an embodiment of an inverter.

FIG. 7 illustrates an embodiment of a method for setting up a battery system with a security manager.

FIG. 8 illustrates an embodiment of a method for operating a battery system with a security manager.

FIG. 9 illustrates an embodiment of a method for remotely deactivating a battery system.

FIG. 10 illustrates an embodiment of a method for using a rolling code to provide battery security.

FIG. 11 depicts a block diagram of an embodiment of a computing device.

### DETAILED DESCRIPTION

The battery security systems and methods described herein prevent or discourage the theft of batteries and related devices, such as inverters. The described battery security system operates with a battery management system (BMS) to prevent the battery from being used if it is stolen. For example, the battery security system may manage a security key or security token that verifies ownership of the battery by the user of the battery. An external control system may communicate with the BMS. In some embodiments, the control system sends the security key (or some hash value based on the security key) and the battery compares it to the stored security key (or stored hash value). If the security key matches (or the hash matches), then the battery operates in its normal manner. However, if the battery is stolen and someone attempts to use the battery with a different (unauthorized) control system, the battery will not operate because it will not receive the proper security key or security token from the BMS.

In the following description, reference is made to the accompanying drawings that form a part thereof, and in which are shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, system, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a solid-state drive, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flow diagram and/or block diagram block or blocks.

The systems and methods described herein prevent or discourage the theft of batteries and related devices. The protected batteries may be associated with electric vehicle charging stations, electric vehicles, battery backup systems for homes or businesses, remote power systems that use one or more batteries, and the like.

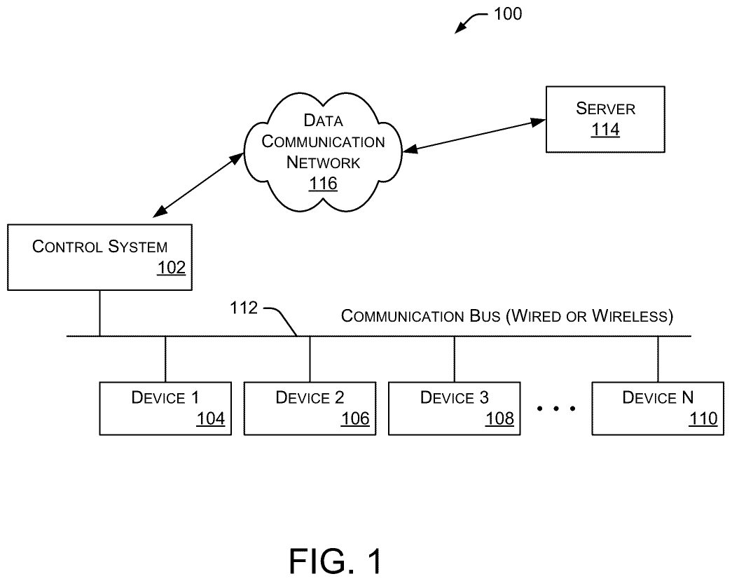

FIG. 1 is a block diagram depicting an embodiment of a battery system 100 for storing energy. As shown in FIG. 1, a control system 102 is coupled to communicate with multiple devices 104, 106, 108, and 110 via a communication bus 112. In some implementations, control system 102 is a computing device or other system capable of performing the functions discussed herein. In particular embodiments, control system 102 may be coupled to any number of devices. As discussed herein, control system 102 may provide security to one or more of devices 104, 106, 108, and 110.

Communication bus 112 may be a wired communication bus or a wireless communication bus using any communication protocol or communication method. In some examples, the configuration of FIG. 1 may be referred to as a star configuration. Multiple devices 104, 106, 108, and 110 may include batteries, inverters, electronic control devices, computing systems, routers, modems, Bluetooth devices, or any other type of device. For example, device 104 may be an inverter and the other three devices 106, 108, and 110 may be batteries. The systems and methods described herein may be applied to any type of battery technology that uses or depends on a BMS. Some BMS systems may provide cell balancing, charge management, and other functions for complex types of batteries such as various lithium-based batteries. In some embodiments, if the battery module has a BMS, the systems and methods described herein can secure the battery module.

Battery system 100 also includes a server 114 coupled to control system 102 via a data communication network 116. Server 114 may be any type of computing device capable of communicating with control system 102 via data communication network 116. Data communication network 116 includes any type of network topology using any communication protocol. Additionally, data communication network 116 may include a combination of two or more communication networks. In some embodiments, data communication network 116 includes a cellular communication network, the Internet, a local area network, a wide area network, or any other communication network.

As discussed herein, server 114 may be used to remotely deactivate a battery that has been stolen by communicating with control system 102 via data communication network 116. For example, server 114 may remotely deactivate a particular battery by sending appropriate instructions or commands to control system 102. In some embodiments, an inverter or electric vehicle (EV) charger may be deactivated in a similar way. For example, after being deactivated, an inverter would not start producing power until it receives a validated security key. Additionally, after being deactivated, an EV charger would not provide energy to charge an EV until it receives a validated security key.

In particular implementations, server 114 may provide various functions for battery charge management. For example, the allowable charging and discharging rates for batteries are often characterized in terms of its “C-rate”, such as 1C, 2C, 3C, etc. The C-rate is a measure of the rate at which a battery is discharged relative to its maximum capacity. For example, a 1C rate means that the discharge current will discharge the entire battery in 1 hour. For a battery with a capacity of 100 Amp-hours, this equates to a discharge current of 100 Amps. In some embodiments, decisions about the C-rate for charging or discharging a battery are made by server 114 or another device controlling a battery. Server 114 may also perform other functions, such as temperature management, cooling management, controlling charge rate in light of temperatures, notification of battery failures, bypassing batteries in case of failures, battery security, and the like. Server 114 and data communication network 116 are optional. These components can be removed if remote deactivation of a battery is not desired.

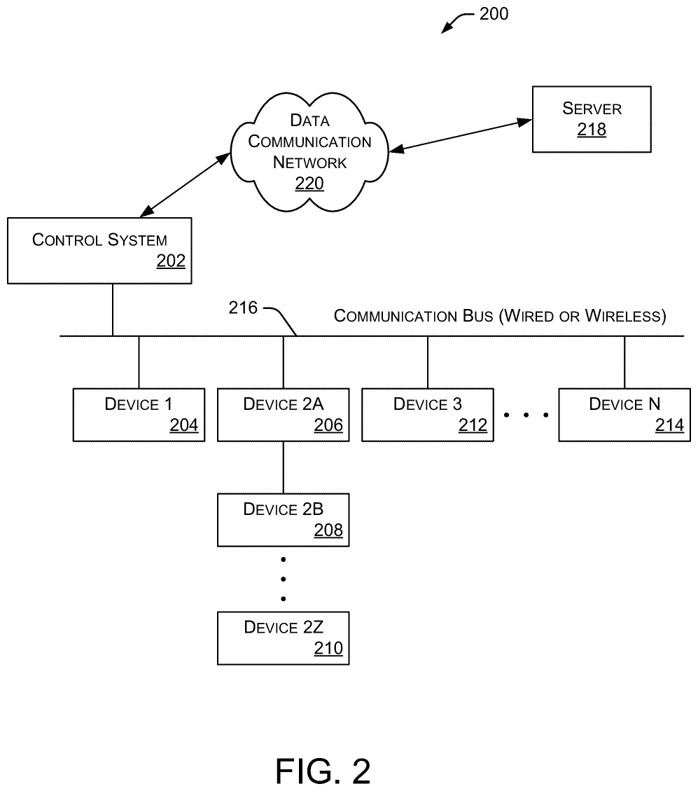

FIG. 2 is a block diagram depicting another embodiment of a battery system 200 for storing energy. As shown in FIG. 2, a control system 202 is coupled to communicate with multiple devices 204, 206, 212, and 214 via a communication bus 216. In some implementations, control system 202 is a computing device or other system capable of performing the functions discussed herein. Additionally, devices 208 and 210 are coupled to device 206. In this configuration, device 206 is a primary device that communicates with control system 202. Devices 208 and 210 are secondary devices that communicate with control system 202 through primary device 206. Although devices 208 and 210 are secondary devices, they may include the same security system as primary device 206. In particular embodiments, control system 202 may be coupled to any number of devices. As discussed herein, control system 202 may provide security to one or more of devices 204, 206, 208, 210, 212, and 214.

Communication bus 216 may be a wired communication bus or a wireless communication bus using any communication protocol or communication method. In some examples, the configuration of FIG. 2 may be referred to as a mesh configuration. Multiple devices 204, 206, 208, 210, 212, and 214 may include batteries, inverters, or any other type of device.

Battery system 200 also includes a server 218 coupled to control system 202 via a data communication network 220, similar to the configuration shown in FIG. 1. As discussed herein, server 218 may be used to remotely deactivate a battery that has been stolen by communicating with control system 202 via data communication network 220. In other embodiments, server 218 may instruct control system 202 to perform other functions or operations associated with one or more of devices 204, 206, 208, 210, 212, or 214. Server 218 and data communication network 220 are optional. These components can be removed if remote deactivation of a battery is not desired.

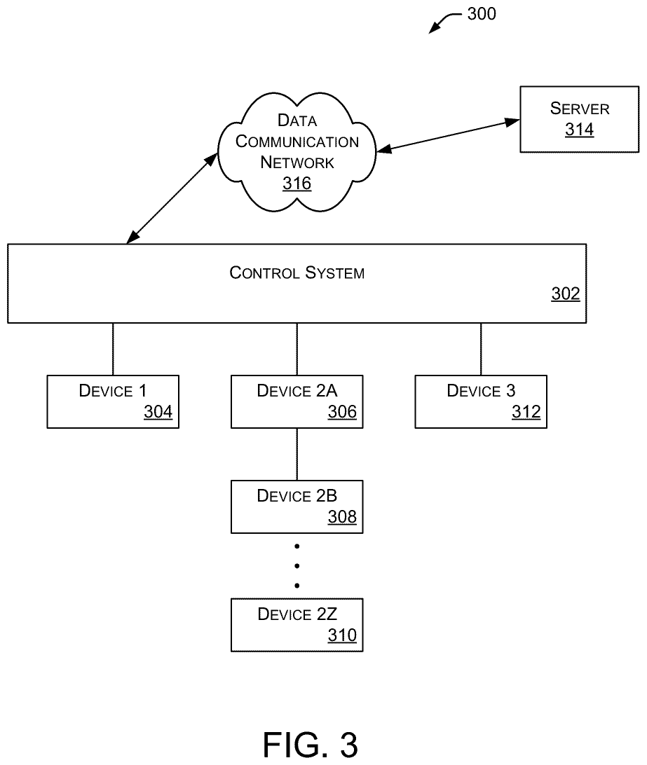

FIG. 3 is a block diagram depicting another embodiment of a battery system 300 for storing energy. As shown in FIG. 3, a control system 302 is coupled to communicate with multiple devices 304, 306, and 312. In some implementations, control system 302 is a computing device or other system capable of performing the functions discussed herein. Additionally, devices 308 and 310 are coupled to device 306. In this configuration, device 306 is a primary device that communicates with control system 302. Devices 308 and 310 are secondary devices that communicate with control system 302 through primary device 306. Although devices 308 and 310 are secondary devices, they include the same security system as primary device 306. In particular embodiments, control system 302 may be coupled to any number of devices.

As discussed herein, control system 302 may provide security to one or more of devices 304, 306, 308, 310, and 312. In some examples, the configuration of FIG. 3 may be referred to as a mesh configuration. Multiple devices 304, 306, 308, 310, and 312 may include batteries, inverters, or any other type of device.

Battery system 300 also includes a server 314 coupled to control system 302 via a data communication network 316, similar to the configuration shown in FIG. 1. As discussed herein, server 314 may be used to remotely deactivate a battery that has been stolen by communicating with control system 302 via data communication network 316. In other embodiments, server 314 may instruct control system 302 to perform other functions or operations associated with one or more of devices 304, 306, 308, 310, and 312. Server 314 and data communication network 316 are optional. These components can be removed if remote deactivation of a battery is not desired.

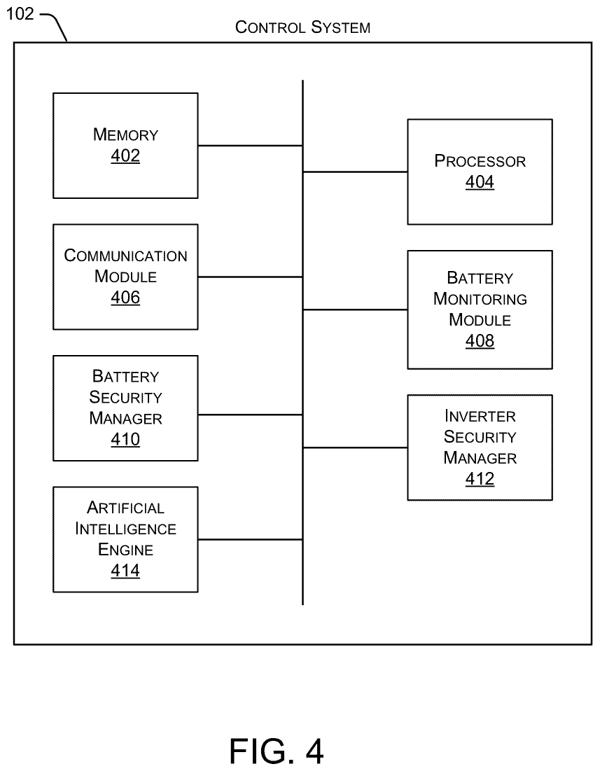

FIG. 4 is a block diagram depicting an embodiment of control system 102 included in a battery system for storing energy. As shown in FIG. 4, control system 102 includes a memory 402, a processor 404, and a communication module 406. Processor 404 executes various instructions to perform the functionality provided by control system 102, as discussed herein. Memory 402 stores these instructions as well as other data used by processor 404 and other modules and components contained in control system 102. Communication module 406 allows control system 102 to communicate with other systems, devices, and the like, such as server 114 and devices 104, 106, 108, and 110.

Control system 102 also includes a battery monitoring module 408 that is capable of monitoring one or more batteries coupled to or associated with control system 102. For example, battery monitoring module 308 may monitor a battery charging status (such as state of charge (SOC) percentage), operating status, and the like for any number of batteries. In some embodiments, control system 102 may monitor various information, such as temperature, cooling system operation, C-rates for charging and discharging, battery cell failures, failed cells that have been bypassed, and security operation.

Control system 102 further includes a battery security manager 410 that manages the security of one or more batteries, as discussed herein. For example, battery security manager 410 may validate each battery using a security key or other security mechanism when the battery is powered up. In some embodiments, battery security manager 410 controls the battery's operating mode (e.g., minimal battery operation or full battery operation) based on whether the battery has been validated or authenticate. In some embodiments, battery security manager 410 can manage the initialization and/or commissioning of the battery security system, including any of the components and systems discussed herein. Battery security manager 410 may also manage the initialization and/or commissioning of security keys, security codes, and the like, as discussed herein. Additional details regarding the battery security process and techniques implemented by battery security manager 410 are described herein.

Control system 102 also includes an inverter security manager 412 that manages the security of one or more inverters, as discussed herein. For example, inverter security manager 412 may validate each inverter using a security key when the inverter is powered up.

Additional details regarding the inverter security process and techniques implemented by inverter security manager 412 are described herein. Inverter security manager 412 may operate in a manner that's similar to the battery security manager, but for an inverter. For example, inverter security manager 412 may help prevent inverter theft. In some embodiments, an inverter could have a token, security key, or other security mechanism that, once lost or not expressed, would cause the inverter not to operate until replaced. In other implementations, inverter security manager 412 may assist with warning about out-of-specification operation or implementing certain utility-required functions, such as low voltage ride-through and other grid stabilizing features, SCADA (Supervisory Control and Data Acquisition) functions, distributed resource monitoring (energy yield, demand charge detection, that sort of thing), and the like.

Additionally, control system 102 includes an artificial intelligence engine 414 that may assist with implementing and managing the battery security systems and methods discussed herein. For example, artificial intelligence engine 414 may analyze operation of an overall system (or portions of that overall system) and data associated with the operation to determine how the system could be better optimized. Once an optimization has been determined, the artificial intelligence engine 414 may automatically perform various control functions that take advantage of that optimization. For example, artificial intelligence engine 414 may perform security monitoring of any number of batteries and automatically take action to disable a battery that is determined to be stolen or missing. Additionally, artificial intelligence engine 414 may detect abnormalities or changes in usage patterns in the operation of a battery or other device and identifying the battery or other device for possible theft.

In some embodiments, control systems 202 and 302 include components and functionality similar to the components and functionality discussed with respect to control system 102 shown in FIG. 4.

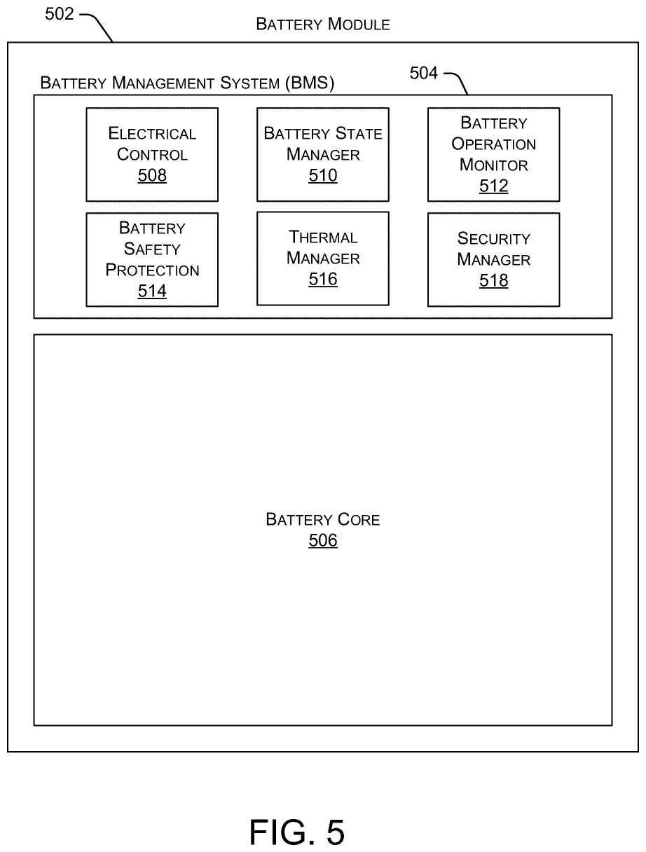

FIG. 5 is a block diagram depicting an embodiment of a battery module 502 including a battery management system (BMS) 504 and a battery core 506. In some embodiments, battery module 502 represents, for example, one or more devices 104, 106, 108, and 110 shown in FIG. 1 or similar devices shown in FIGS. 2 and 3.

As shown in FIG. 5, battery module 502 includes BMS 504 and battery core 506. BMS 504 manages a rechargeable battery (e.g., battery core 506) by, for example, monitoring the state of the battery, protecting the battery from operating outside its safe operating environment, balancing the battery's state of charge or voltage relative to other batteries in the same array, controlling the operation of the battery, and the like. Battery core 506 provides, for example, one or more rechargeable cells that receive energy from an energy source and, at a later time, output the energy to another device or system. The systems and methods discussed herein are useful with any type of battery created using any chemicals or substances.

In some embodiments, BMS 504 includes an electrical control 508, a battery state manager 510, and a battery operation monitor 512. Electrical control 508 manages and controls various electrical aspects of battery module 502 and/or battery core 506. Battery state monitor 510 manages the state of battery module 502 and/or battery core 506. Battery operation monitor 512 manages the operation of battery module 502 and/or battery core 506, such as charging or discharging operations.

BMS 504 also includes battery safety protection 514, thermal manager 516, and security manager 518. Battery safety protection 514 monitors the overall operation of battery module 502 and/or battery core 506 to be sure the battery is operating within safe parameters. Thermal manager 516 monitors the thermal characteristics of battery module 502 and/or battery core 506 to be sure the battery is operating within an acceptable thermal range. Security manager 518 performs various security operations, such as storing security keys, storing tokens, communicating with a control system for validation of battery module 502, and the like. Additional details regarding the security operations performed by security manager 518 are discussed herein.

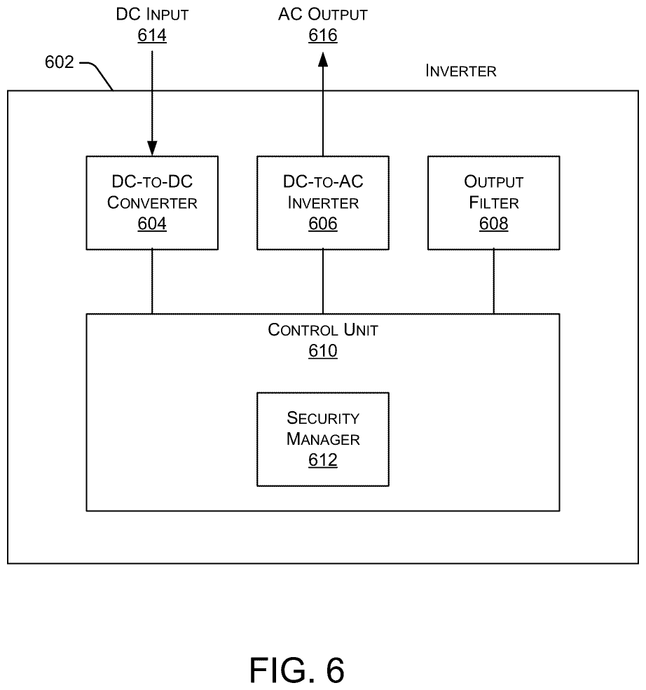

FIG. 6 is a block diagram depicting an embodiment of an inverter 602. As shown in FIG. 6, inverter 602 includes a DC-to-DC converter 604, a DC-to-AC inverter 606, and an output filter 608 coupled to a control unit 610. The purpose of an inverter is to convert inbound electrical energy in direct current (DC), such as from solar panels or a wind generator, into outbound electrical energy in alternating current (AC), which can be delivered into either a load or a utility grid. As shown in the embodiment of FIG. 6, a DC input 614 is provided to DC-to-DC converter 604 and an AC output 616 is created by DC-to-AC inverter 606.

In some embodiments, control unit 610 performs various security operations, such as storing security keys, storing tokens, communicating with a control system for validation of inverter 602, and the like. Example control functions may include monitoring voltage ranges, monitoring frequency ranges, providing various grid-stabilizing features, detecting a security key associated with an inverter, validating the security key, disabling an inverter if the security key is not validated, and the like. Additional details regarding the security operations performed by security manager 612 are discussed herein.

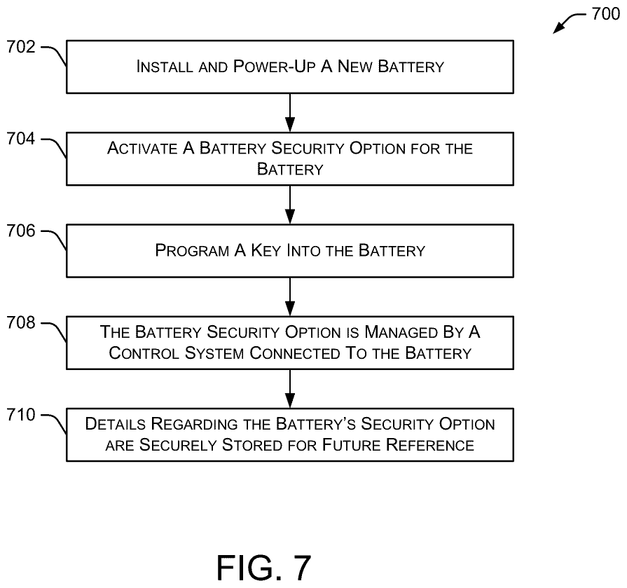

FIG. 7 illustrates an embodiment of a method 700 for setting up a battery system with a security manager. Initially, a new battery is installed and powered-up at 702. The installation may include a physical installation of a battery (e.g., battery module 502) and connecting the battery to communicate with a control system (e.g., control system 102). Method 700 continues as a battery security option is activated for the battery at 704. The battery security option may include, for example, no battery security or active battery security that prevents use of the battery without a security key, token, or other security technique. The security key, token, or other security technique may be referred to as “security credentials.” The remainder of method 700 includes steps associated with setting up a battery with active security.

At 706, method 700 programs a key into the battery. The method 700 continues as the battery security option is managed by a control system connected to the battery at 708. Details regarding the battery's security option are securely stored at 710 for future reference. For example, the key and the serial number of the associated battery may be securely stored on a server or other device for future access. In some embodiments, a factory key may be available to erase the existing key associated with a battery, unlock the battery, and restore the battery to its default settings with no security protection activated.

In some embodiments, the method of FIG. 7 is performed once for each battery to program a key into the battery device. That key is known to a control system connected to the battery and used by the control system to validate the battery in the future. If someone attempts to operate the battery without the proper key, the battery will not operate (e.g., it may deliver minimal current or minimal voltage until a proper key is validated).

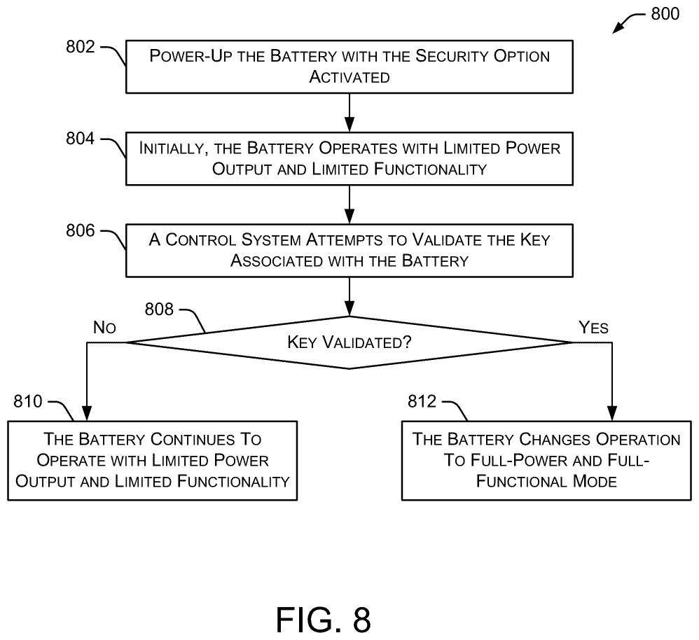

FIG. 8 illustrates an embodiment of a method 800 for operating a battery system with a security manager. Method 800 begins as a battery is powered-up at 802 with the security option activated. Initially, at 804, the battery operates with limited power output and/or limited functionality. For example, the battery may produce limited voltage, limited current, reduced functionality, and the like. This limited power output and/or limited functionality may be referred to as “partially disabling the battery.” The battery operates with limited power so its systems can perform basic operations and the battery can communicate with the control system for validation. Additionally, the limited power may be provided to the control system to allow the control system to operate as described herein. Although the battery is producing limited power, it is significantly less than the battery's full operating power. Thus, when operating in the limited power mode, the battery has minimal value for its intended purpose. The limited functionality may include, for example, preventing firmware updates, limiting power output to just a few watts or milliwatts or other programmed value, and the like. In some embodiments, the purpose of providing “limited power” is to allow the battery to operate the control system, which is necessary for it to be able to check its key (e.g., security key). Additionally, the limited power allows other systems to confirm that the battery is operating (e.g., the battery is not dead). But the limited power will not permit the battery to power other loads (just the control system). Thus, the limited power has no significant value to someone who has stolen the battery or does not have approval to use the battery.

The method continues as a control system attempts to validate at 806 the key associated with the battery. The method determines at 808 whether the key was validated. If the key was not validated, the battery continues to operate 810 with limited power output and/or limited functionality. If the key is successfully validated, the battery changes operation to full-power and full-functional mode at 812. Thus, once the battery has been validated as being operated by the owner, the control system allows the battery to operate with full power and all functions. However, if the battery has been stolen, or otherwise used by someone other than the owner, the battery is restricted to limited power output and limited functionality, which reduces the value of the battery to the unauthorized user.

Various approaches can be implemented to unlock a battery being managed by a control system. One approach transmits a key to the device to unlock it, similar to a password. This approach is simple but less secure than other approaches because any device that has the correct key can unlock the battery.

Another approach to unlock a battery includes, for example:
1. A host requests a magic number (MN) or generates it using some kind of sequencing algorithm (e.g., a real time clock could be used to obtain such a number). For example, the magic number may be a 32-bit random number and may be cryptographically secure.
2. A device generates a one-time-use value and provides it to the host.
3. The host computes a crypto-hash value similar to HMAC (MN, Key). HMAC refers to a Hash based Method Authentication Code, which is a type of message authentication code involving a cryptographic hash function and a secret cryptographic key.
4. The device computes the same crypto-hash value.
5. The hash is then transmitted to the device.
6. If the transmitted hash matches the value computed by the device, then the device unlocks.
7. The device erases the magic number that was used to generate the crypto-hash so that another device or host will not be able to create the same hash.

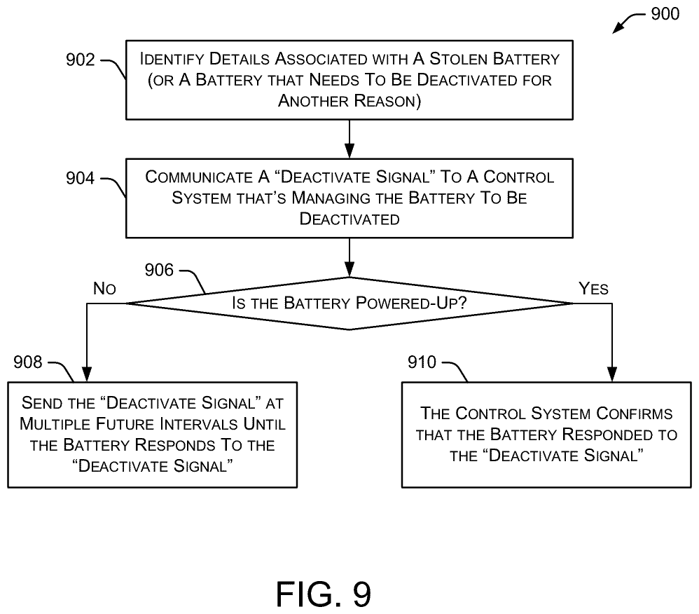

FIG. 9 illustrates an embodiment of a method 900 for remotely deactivating a battery system, for example, if it has been stolen. Initially, method 900 identifies details associated with a stolen battery (or a battery that needs to be deactivated for another reason, such as failure of a customer to make a lease payment or purchase payment for the battery) at 902. The method continues as the control system communicates 904 a “deactivate signal” to a control system that's responsible for managing the battery to be deactivated. The method continues by determining 906 whether the battery is powered-up. If the battery is not powered-up, the control system sends 908 the “deactivate signal” at multiple periodic future intervals until the battery responds to the “deactivate signal.” If the battery is powered up, the control system confirms 910 that the battery responded to the “deactivate signal.” If the battery responded to the “deactivate signal,” then the battery is deactivated and cannot be used until the owner retrieves the battery and unlocks the key and/or other security features. When the battery is deactivated, it has no value to anyone except the owner. Thus, the security features discussed herein may operate as a deterrent to stealing batteries, inverters, and other devices.

In some embodiments, a deactivated battery may be re-activated using a secret key sent to the battery. In particular implementations, the secret key used to re-activate the battery is a one-time use key, which can only be used once to re-activate the battery. If, after re-activation, the battery is again deactivated it cannot be re-activated using a secret key. Instead, the deactivated battery needs to be manually re-commissioned to reset the battery for operation.

In some embodiments, deactivation of a battery may be self-initiated by the battery. In some embodiments, a battery may be designed with an internal “heartbeat” that is required to “keep it alive.” The “heartbeat” may also be referred to as a watchdog timer. As long as the heartbeat keeps pulsing in software, the battery can provide full power. In some implementations, the source of the heartbeat is the battery's position or operation inside a larger battery system. If the battery module is removed from that larger system (e.g., stolen) and the heartbeat is lost, then the battery itself may take the action of shutting itself down (e.g., deactivating the battery).

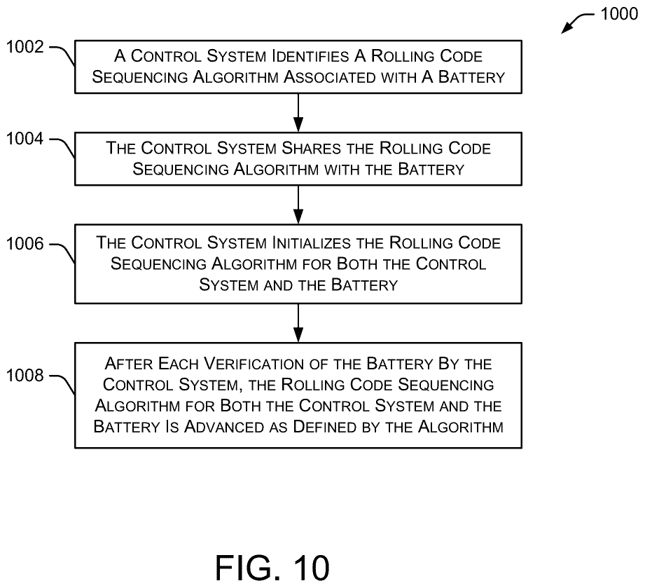

FIG. 10 illustrates an embodiment of a method 1000 for using a rolling code to provide battery security. Initially, a control system identifies 1002 a rolling code sequencing algorithm associated with a battery. The control system then shares 1004 the rolling code sequencing algorithm with the battery. Method 1000 continues as the control system initializes 1006 the rolling code sequencing algorithm for both the control system and the battery. This initialization synchronizes the control system with the battery for purposes of the rolling code sequencing algorithm. After each verification of the battery by the control system, the rolling code sequencing algorithm for both the control system and the battery is advanced 1008 as defined by the algorithm. Thus, the battery and the control system remain synchronized because they are both using the same algorithm to determine the next code. In some embodiments, the generation of rolling codes may be used as a method to generate successive hash codes as described herein.

In some embodiments, the systems and methods described herein may provide a technique for changing the key associated with a battery. Additionally, certain embodiments of the battery include the ability to set the power output value or define limits of the functionality when the battery is in “locked” mode (e.g., not yet validated).

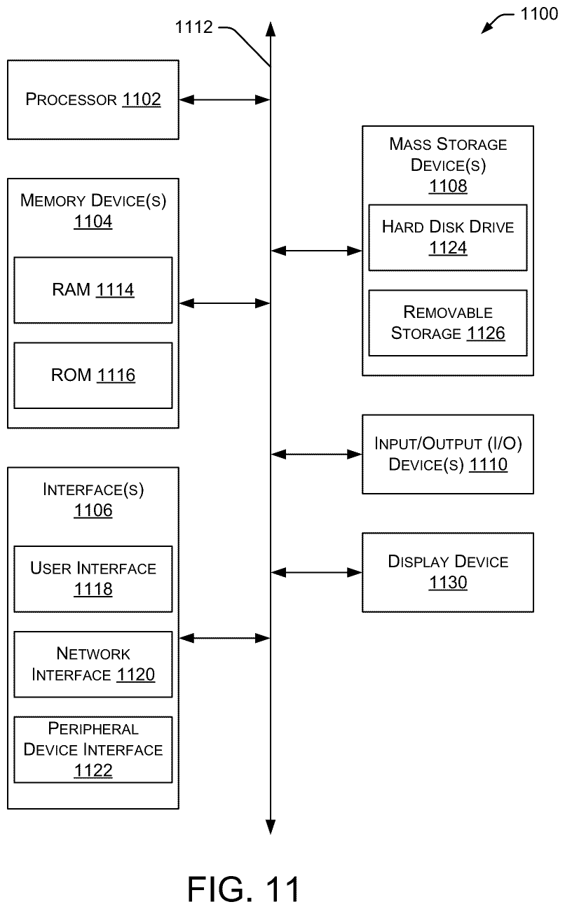

FIG. 11 depicts a block diagram of an embodiment of a computing device 1100.

Computing device 1100 may be used to perform various procedures, such as those discussed herein. Computing device 1100 can execute one or more application programs, such as the application programs, firmware, or functionality described herein. Computing device 1100 can be any of a wide variety of computing devices, such as an embedded or dedicated processor, a desktop computer, a notebook computer, a server computer, a handheld computer, tablet computer, a wearable device, and the like.

Computing device 1100 includes one or more processor(s) 1102, one or more memory device(s) 1104, one or more interface(s) 1106, one or more mass storage device(s) 1108, one or more Input/Output (I/O) device(s) 1110, and a display device 1130 all of which are coupled to a bus 1112. Processor(s) 1102 include one or more processors or controllers that execute instructions stored in memory device(s) 1104 and/or mass storage device(s) 1108. Processor(s) 1102 may also include various types of computer-readable media, such as cache memory.

Memory device(s) 1104 include various computer-readable media, such as volatile memory (e.g., random access memory (RAM) 1114) and/or nonvolatile memory (e.g., read-only memory (ROM) 1116). Memory device(s) 1104 may also include rewritable ROM, such as Flash memory.

Mass storage device(s) 1108 include various computer readable media, such as magnetic tapes, magnetic disks, optical disks, solid-state memory (e.g., Flash memory), and so forth. As shown in FIG. 11, a particular mass storage device may be a hard disk drive 1124. Various drives may also be included in mass storage device(s) 1108 to enable reading from and/or writing to the various computer readable media. Mass storage device(s) 1108 include removable media 1126 and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, and the like.

Display device 1130 includes any type of device capable of displaying information to one or more users of computing device 1100. Examples of display device 1130 include a smartphone, an external PC, a monitor, display terminal, video projection device, and the like.

Interface(s) 1106 include various interfaces that allow computing device 1100 to interact with other systems, devices, or computing environments. Example interface(s) 1106 may include any number of different network interfaces 1120, such as interfaces to local area networks (LANs), wide area networks (WANs), wireless networks, cellular modem networks, and the Internet. Interface(s) 1106 may further include an external smartphone (or other portable computing device) that uses a browser as an interface to cloud-based computing systems and the like. Other interface(s) include user interface 1118 and peripheral device interface 1122. The interface(s) 1106 may also include one or more user interface elements 1118. The interface(s) 1106 may also include one or more peripheral interfaces such as interfaces for printers, pointing devices (mice, track pad, or any suitable user interface now known to those of ordinary skill in the field, or later discovered), keyboards, and the like.

Bus 1112 allows processor(s) 1102, memory device(s) 1104, interface(s) 1106, mass storage device(s) 1108, and I/O device(s) 1110 to communicate with one another, as well as other devices or components coupled to bus 1112. Bus 1112 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1100, and are executed by processor(s) 1102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. An apparatus comprising:
a control system configured to manage access to at least one battery; and
a battery module coupled to the control system and configured to control access to energy stored in a battery core, the battery module further comprising:
a battery operation manager configured to control operation of the battery module; and
a security manager configured to control security of the battery module, wherein controlling security of the battery module includes at least one of storing security keys, storing tokens, retrieving security keys, retrieving tokens, validating security keys, validating tokens, or communicating with the control system for validation of the battery module.

2. The apparatus of claim 1, wherein controlling operation of the battery module includes at least one of charging the battery core, discharging the battery core, or determining a mode of operation of the battery module.

3. The apparatus of claim 1, further comprising a battery state monitor configured to monitor a current state of the battery core.

4. The apparatus of claim 1, wherein the control system includes a battery security manager configured to restrict access to the battery module based on received security credentials.

5. The apparatus of claim 4, wherein the battery security manager further controls operation of the battery module by instructing the battery module to be in a first mode of operation or a second mode of operation based on received security credentials.

6. The apparatus of claim 5, wherein:
the first mode of operation allows the battery module to operate with reduced functionality when security credentials have not been received or validated; and
the second mode of operation allows the battery module to operate with full functionality after security credentials have been received and validated.

7. The apparatus of claim 1, wherein the battery module includes a battery state manager configured to control the operation of the battery core.

8. The apparatus of claim 1, wherein the battery module includes a battery safety protection module configured to control the safe operation of the battery core.

9. The apparatus of claim 1, wherein the battery module includes a security manager configured to control access to energy stored in the battery core based on instructions from the control system.

10. The apparatus of claim 1, wherein the battery operation manager is further configured to deactivate a particular battery by communicating a deactivate signal to the particular battery.

11. A method comprising:
powering-on a battery module that has a battery security option activated;
setting operation of the battery module in a first mode of operation that allows the battery module to operate with reduced functionality;
receiving a security key associated with the battery module;
attempting to validate the security key associated with the battery module; and
changing operation of the battery module to a second mode of operation responsive to validation of the security key, wherein the second mode of operation allows the battery module to operate with full functionality.

12. The method of claim 11, wherein the first mode of operation includes at least one of limiting the battery module's voltage, limiting the battery module's current, or limiting functions that the battery module can perform.

13. The method of claim 11, wherein the second mode of operation includes providing full battery module voltage, providing full battery module current, and allowing the battery module to perform all available functions.

14. The method of claim 11, further comprising deactivating the battery module responsive to receiving a deactivation signal from a control system.

15. The method of claim 11, wherein changing operation of the battery module to a second mode of operation is initiated by a battery state manager.

16. The method of claim 11, wherein validation of the security key associated with the battery module is implemented by a security manager.

17. A method comprising:
identifying details associated with a battery that needs to be deactivated;
communicating a deactivate signal to a control system that is managing the battery to be deactivated;
determining whether the battery to be deactivated is powered-up;
responsive to determining that the battery is powered-up, sending the deactivate signal to the battery to be deactivated; and
responsive to determining that the battery is not powered-up, sending the deactivate signal to the battery at multiple future intervals until the battery responds to the deactivate signal.

18. The method of claim 17, further comprising updating the battery status to deactivated in response to receiving a confirmation of the deactivate signal from the battery.

19. The method of claim 17, further comprising reactivating the deactivated battery by sending a new security key to the deactivated battery.
